(19) United States
(12) Patent Application Publication
(10) Pub. No.: US 2009/0049347 A1
(43) Pub. Date: Feb. 19, 2009

(54) Method and apparatus for bit error determination in multi-tone transceivers

(75) Inventors: Avadhani Shridhar, Santa Clara, CA (US); Sam Heidari, Los Altos Hills, CA (US)

Correspondence Address: IP CREATORS, P. O. BOX 2789, CUPERTINO, CA, 95015, US

(73) Assignee: IKANOS Communication, Inc., A California Corporation, Fremont, CA (US)

(21) Appl. No.: 12/228,972

(22) Filed: Aug. 18, 2008

Related U.S. Application Data
(60) Provisional application No. 60/956,338, filed on Aug. 16, 2007.

(51) Int. Cl. G06F 11/00

(52) U.S. Cl. 714/704; 714/E11.001

(57) ABSTRACT

A transceiver with a plurality of components coupled to one another to form a transmit path and a receive path for multi-tone modulation of user data across a communication medium. The transceiver includes a framer and a deframer. The framer is configured to momentarily suspend framing of user data before processing bits associated with tones targeted for reference data transport and injects the pre-agreed reference pattern therein, after which framing of user data resumes. The deframer is configured to momentarily suspend deframing of received user data bits before processing bits associated with tones targeted for transport of pre-agreed reference data and extracts the received reference bits thereof for comparison with the corresponding pre-agreed reference bits to determine errors therein, after which deframing of user data resumes.

### CROSS REFERENCE TO RELATED APPLICATION

This application claims the benefit of prior filed co-pending Provisional Application No. 60/956,338 filed on Aug. 16, 2007 entitled “Measurement of BER per Tone in DSL Modems” (Attorney Docket: VELCP077P) which is incorporated herein by reference in its entirety as if fully set forth herein.

### BACKGROUND OF THE INVENTION

1. Field of Invention

The field of the present invention relates to multi-tone transceivers.

2. Description of the Related Art

In a digital multi-tone (DMT) based DSL systems (such as ADSL, ADSL2, ADSL2+, VDSL1, VDSL2), modems at either end of a telephone line, go through a training phase which determines the data rate that is to be sent over the line in both downstream and upstream directions. In each direction, the transmit part of the modem sends a known reference pattern on the line which is used by the receiver part of the modem at the other end of the line, to estimate the signal-to-noise ratio (SNR) on each of the tones. Based on the SNR of a tone, the constellation size that can be loaded is determined. This bit loading is typically done with some noise margin, say ‘M’ db, such that noise can increase by this noise margin amount of M db, without increasing the bit error rate (BER) beyond the target error rate. The bit table information consisting of the constellation size and the gain on each of the tones is exchanged between the modems and agreed on. The sum of the bits loaded on each tone is the bits per symbol in that direction, indicated by ‘Lₛ’ in that direction. The modem's throughput in a direction, known as line rate, is calculated by multiplying ‘Lₛ’ with the symbol rate.

At the end of the initialization, the modems go into “showtime” mode, where the modems start transmitting the user's payload data. The payload data is put into a DSL framing structure which defines a “frame” consisting of user payload data bytes, as well as overhead bytes and error correcting parity bytes (such as Reed-Solomon parity bytes). The overhead bytes are used for exchanging messages for operation and management of the modems. The bytes coming from the framing are sent through an interleaver for improving noise immunity to impulse noise. The interleaver output bytes are then modulated on to the tones as per the bit and gain tables agreed upon during initialization.

A change in bit-loading may also take place during this showtime phase, when for example, noise increases, e.g. due to additional lines coming up in a binder. The DSL standards have defined a procedure known as Seamless Rate Adaptation (SRA) for allowing rate adaptation during showtime. In the SRA method, the modems check the current SNR, and if the noise has changed, a bit loading based on the current SNR is performed, and if the noise has increased, then the line rate can be reduced by the new bit loading, and vice versa. The modems effect this change by the use of overhead bytes to exchange the new bit table information, and then switch to the new bit table on a specific symbol, thereby changing the line rate to match the new noise conditions.

SRA relies on SNR determinations made during showtime. SNR determinations made during this phase of modem operation are not absolute in that the underlying user data associated with each received symbol is not known. As a result SNR of a tone determined by measuring the root mean squared (RMS) error between a received tone and its nearest valid constellation point may not always correspond to the actual error experienced in the demodulated bits. As broadband throughput requirements increase the acceptable error rates defined by standard bodies are actually being reduced to 10⁻⁷ or less. Thus inaccuracies in SNR based showtime rate adaptation will negatively impact the measured error levels of the communication channel.

What is needed is an improved method for showtime sub-channel characterization.

### SUMMARY OF THE INVENTION

A multi-tone transceiver for multi-tone communications is disclosed. The multi-tone transceiver supports communication channels with showtime operation which supports scheduled, selectable or error driven mixing of both reference data and user data for determination of bit errors in one or more tones or sub-channels of the communication channel.

In an embodiment of the invention a transceiver is disclosed with a plurality of components coupled to one another to form a transmit path and a receive path for multi-tone modulation of user data across a communication medium. The transceiver includes a framer and a deframer. The framer is configured to momentarily suspend framing of user data before processing bits associated with tones targeted for reference data transport and to inject a pre-agreed reference pattern therein, after which framing of user data resumes. The deframer is configured to momentarily suspend deframing of received user data bits before processing bits associated with tones targeted for transport of pre-agreed reference data and extracts the received reference bits thereof for comparison with the corresponding pre-agreed reference bits to determine errors therein, after which deframing of user data resumes.

In another embodiment of the invention an improvement is disclosed in a communications system having a pair of modems supporting multi-tone modulated communication of user data over a subscriber line. The improvement comprises a framer in a first of the pair of modems configured to momentarily suspend framing of user data before processing bits associated with tones targeted for reference data transport and to inject a pre-agreed reference pattern therein, after which framing of user data resumes. The improvement also comprises a deframer in a second of the pair of modems configured to momentarily suspend deframing of received user data bits before processing bits associated with the tones targeted for transport of the pre-agreed reference data and to extract the received reference bits thereof for comparison with the corresponding pre-agreed reference bits to determine errors therein, after which deframing of user data resumes.

### BRIEF DESCRIPTION OF THE DRAWINGS

These and other features and advantages of the present invention will become more apparent to those skilled in the art from the following detailed description in conjunction with the appended drawings in which:

FIG. 1 is a system diagram of an embodiment of the invention in which the transceivers comprise multi-tone modems coupled to one another via a subscriber line;

FIGS. 2A and 2C are graphs of bit loading versus sub-carrier index for a multi-tone modulated communication channel during the modems' training and showtime phases of operation respectively;

FIGS. 2B and 2D are constellation graphs of a single sub-channel during the modems' training and showtime phases of operation respectively;

FIG. 3A is a graph of bit loading during the modems' showtime phase of operation in an embodiment of the invention in which a mix of both reference and user data are transported on the communication channel;

FIG. 3B is a constellation graph for a selected sub-channel during the modems' showtime phase of operation shown in FIG. 3A;

FIG. 4 is a detailed hardware block diagram of transmit and receive portions respectively of the multi-tone modems shown in FIG. 1;

FIG. 5A is a data transport diagram showing user and reference data in both the transport control layer and the physical media dependent layer for an embodiment of the invention;

FIG. 5B is a data transport diagram showing user and reference data in both the transport control layer and the physical media dependent layer for an alternate embodiment of the invention;

FIG. 6 is a detailed hardware block diagram of one of the modems shown in FIG.

FIG. 7 is a process flow diagram of transmit and receive processing for the modems shown in FIG. 1 in accordance with an embodiment of the invention.

### DETAILED DESCRIPTION OF THE EMBODIMENTS

A multi-tone transceiver for multi-tone communications is disclosed. The multi-tone transceiver supports communication channels with showtime operation which supports scheduled, selectable or error driven mixing of both reference and user data for determination of bit errors in one or more tones or sub-channels of the communication channel. Supported multi-tone communication protocols include but are not limited to the following:

TABLE 1

| | | Downstream | Upstream |
|---|---|---|---|
| Standard name | Common name | rate | rate |
| ANSI T1.413-1998 | ADSL | 8 Mbit/s | 1.0 Mbit/s |
| Issue 2 | | | |
| ITU G.992.1 | ADSL (G.DMT) | 8 Mbit/s | 1.0 Mbit/s |
| ITU G 992 1 Annex A | ADSL over POTS | 8 Mbit/s | 1.0 MBit/s |
| ITU G.992.1 Annex B | ADSL over ISDN | 8 Mbit/s | 1.0 MBit/s |
| ITU G.992.2 | ADSL Lite (G.Lite) | 1.5 Mbit/s | 0.5 Mbit/s |
| ITU G.992.3/4 | ADSL2 | 12 Mbit/s | 1.0 Mbit/s |
| ITU G 992 3/4 Annex J | ADSL2 | 12 Mbit/s | 3.5 Mbit/s |
| ITU G.992.3/4 Annex L | RE-ADSL2 | 5 Mbit/s | 0.8 Mbit/s |
| ITU G.992.5 | ADSL2+ | 24 Mbit/s | 1.0 Mbit/s |
| ITU G.992.5 Annex L^{[1]} | RE-ADSL2+ | 24 Mbit/s | 1.0 Mbit/s |
| ITU G.992.5 Annex M | ADSL2 + M | 24 Mbit/s | 3.5 Mbit/s |
| ITU G.993.1 | VDSL | | |
| ITU G.993.2 | VDSL 2 | | |
| IEEE 802.16e | WiMax | | |
| IEEE 802.20 | Mobile Broadband | 1 Mbit/s | 1 Mbit/s |
| | Wireless Access | | |

XDSL modems use discrete multi-tone (DMT) transmit data modulated on a set of sub-channels, referred to as tones. The number of tones, the spacing between tones and the range of frequency spectrum that can be used varies depending on the standard. For example, ADSL2+ uses 512 tones in the downstream direction with a tone spacing of 4.3125 Khz to cover a spectrum of 2.2 Mhz.

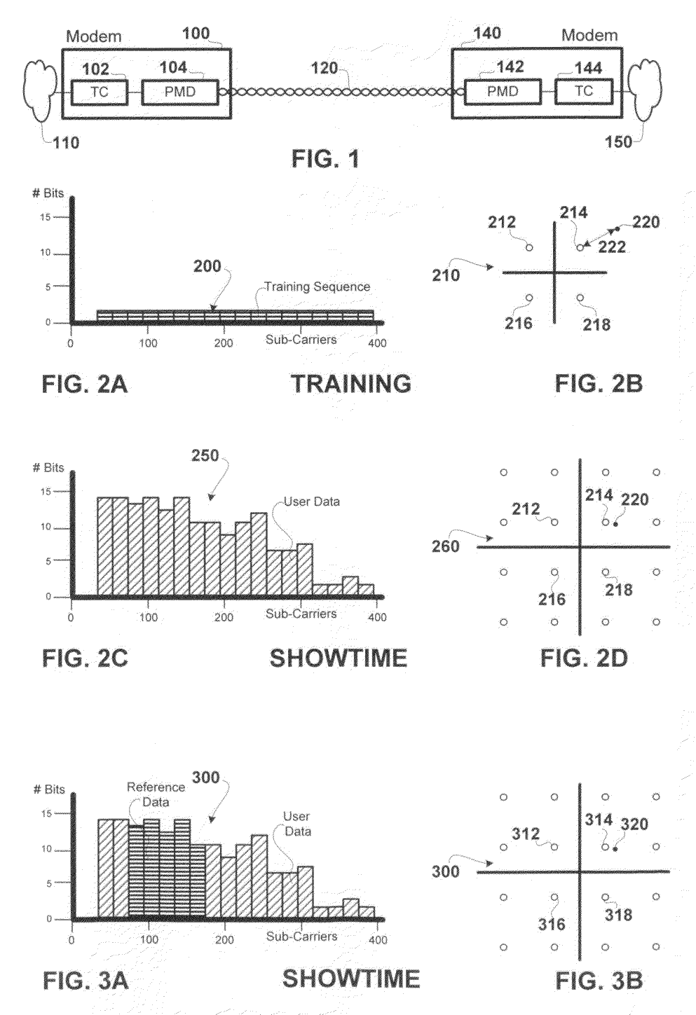

FIG. 1 is a system diagram of an embodiment of the invention in which the transceivers comprise multi-tone modems coupled to one another via a subscriber line. Modems 100 and 140 are shown coupled to one another via a subscriber line 120 for the transport of user data between networks 110 and 150 respectively.

The transmit portions of modem 100 include: a transmission convergence (TC) layer 102 which handles the byte level interface with network 110 and a physical media dependent (PMD) layer 104 which handles the modulation of each byte of user data onto the subscriber line 120. The receive portions of modem 140 include: a TC layer 144 which handles the byte level interface with network 150 and a PMD D layer 142 which handles demodulation of each byte of user data from the subscriber line 120.

The data to be transmitted is sent through a transmission convergence (TC) layer which processes the data and creates DSL frames. The processing done includes scrambling, adding cyclic redundancy check (CRC) and overhead bytes, Reed-Solomon encoding, and interleaving. The data bits from the TC layer are then sent to the Physical Media Dependent layer (PMD layer). The PMD layer modulates the data bits sent by the TC layer on a set of tones and then performs an inverse discrete Fourier transform (IDFT) to transform it to the time domain. Various time domain processing such as transmit windowing, interpolation, and filtering are typically done before sending the data to a digital-to-analog converter (DAC) and line driver for sending the signal on the line. A bit table is agreed between the modems which indicates the sequence in which bytes are to be allocated to tones and for each tone the number of bits that can be modulated onto that tone.

On the receiver side, the data from the analog-to-digital converter (ADC) is sent through various time domain processing such as filtering, echo cancelling, equalization, and then a discrete Fourier transform (DFT) is performed to transform the received data into the frequency domain, followed by frequency domain equalization. The bit table agreed between the two modems is used to determine the constellation size sent by the transmitter on each tone, which is then demodulated to get a set of bits from each tone. These demodulated bits are then sent out in the sequence based on the tone orderer given by this pre-agreed bit table.

In alternate embodiments of the invention the communication medium may comprise a wireless communication medium.

FIGS. 2A and 2C are graphs of bit loading versus sub-carrier index for a multi-tone modulated communication channel during the modems' training and showtime phases of operation respectively. FIGS. 2B and 2D are constellation graphs of a single sub-channel during the modems' training and showtime phases of operation respectively.

FIG. 2A shows a representative training phase bit loading on each of the sub-channels supported by the modems. During training all sub-channels have a uniform bit loading. During training each tone is modulated at constant amplitude with respect to a corresponding sub-channel carrier signal in one of four phase relationships determined by the four possible combinations of the 2 bit number modulated onto each sub-channel or tone. FIG. 2B shows a training phase constellation 210 with four possible constellation point values 212-218 shown. Signal-to-noise ratios (SNR) are determined by repetitive measurement of the error, e.g. error 222, between the tone's received point, e.g. point 220, and the target constellation point, e.g. 214, associated with the modulated 2 bit value allocated into the corresponding tone or sub-channel. SNR of a tone is the average of the signal power to the noise power of that tone or sub-channel averaged in time across a number of symbols.

During training a representative SNR is determined for each sub-channel using the known training sequence. From this information optimal bit loading is determined for each tone. Tones or sub-channels having a high signal-to-noise ratio are allocated relatively more bits than tones with relatively lower signal-to-noise ratios. A bit loading table records for each tone the corresponding bit loading.

FIG. 2C shows a representative bitloading in the showtime phase of operation of the modems. In this phase of operation bit loading on each tone or sub-channel is based on the bit loading table determined during training. Bit loading on a sub-channel is proportional to the SNR for the channel determined during training. Bit loading during showtime is significantly greater than during the training phase. FIG. 2D shows a representative showtime constellation 260 with a greater bit loading than during the training phase of operation. Symbols 212-218 are shown surrounded by an expanded constellation consistent with the higher bit loading of this sub-channel during showtime.

As discussed above, seamless rate adaptation (SRA) provides for showtime based changes in bit loading in response to changing noise levels on the communication medium. Bit loading determinations are based on the SNR as measured during showtime. If the noise has increased, then the line rate can be reduced by the new bit loading, and vice versa. The modems effect this change by the use of overhead bytes to exchange the new bit table information, and then switch to the new bit table, thereby changing the line rate to match the new noise conditions. SNR determinations made during showtime are not absolute in that the underlying user data associated with each received symbol is not known. As a result, SNR of a tone determined by measuring the root mean squared (RMS) error between the received tone and its nearest valid constellation point may not always correspond to the actual error experienced in the demodulated bits. For example, in FIG. 2D, when the received point was 220, the actual transmitted constellation could have been 218, while the SNR measures the error with respect to constellation point 214. Thus inaccuracies in SNR based showtime rate adaptation will negatively impact the measured error levels of the communication channel. Additionally, intermittent noise having a time interval shorter than that associated with the measured SNR interval may increase bit errors without significant impact on SNR.

FIG. 3A is a graph of bit loading during the modems' showtime phase of operation in an embodiment of the invention in which a mix of both reference and user data are transported on the communication channel. The reference data comprises a known pattern transmitted by one of the modems, the pattern of which is known on a per tone basis by the receiving one of the opposing modems. On the receiving one of the modems the bits received on the selected tone(s) are compared with the actual reference data injected into those tones. The bit error of a tone is measured by counting the number of bits on the tone which are in error, and dividing the errored bit sum by the total number of bits on the selected tone in this period of time. This BER per tone can be useful to debug and optimize modem performance. For example, it is useful to know if the errors are caused by a group of consecutive tones (a frequency band), or by a frequency and its harmonics, or by tones which are at the boundary between downstream and upstream, etc. The BER per tone can also be used after deployment in the field, to collect statistics for noise sources periodically. For example, the operator could initiate the measurement under different expected noise conditions. This could also be done automatically by the modem, for example, if there is no user data traffic for a long time (for example in the night), BER per tone can be initiated.

In the embodiment of the invention shown in FIG. 3A reference data and user data are mixed within each symbol or tone set. This method of injection identified as intra-symbol mixing of reference data and user data has the advantage of both reduced processing requirements for bit error determination as well as uninterrupted transport of user data albeit at a temporarily reduced rate. Additionally, all tones in a tone set can be characterized simply by shifting the reference data to different sub-sets of the tones in succeeding symbol intervals. In an alternate embodiment of the invention reference data is injected into entire symbols or tone sets during which interval transport of user data is suspended. This alternate method of injection is identified as inter-symbol mixing of reference data and user data.

Either embodiment of the invention has the benefit of allowing accurate bit error measurement on either or both the upstream or downstream channels during showtime and without return to the training phase. The reference data allows the corresponding sub-channels to be accurately characterized in terms of bit errors. The bit error determination for each tone, may be used for diagnostic purposes or for changes to showtime bit loading.

FIG. 3B is a constellation graph for a selected sub-channel 300 during the modems' showtime phase of operation shown in FIG. 3A.

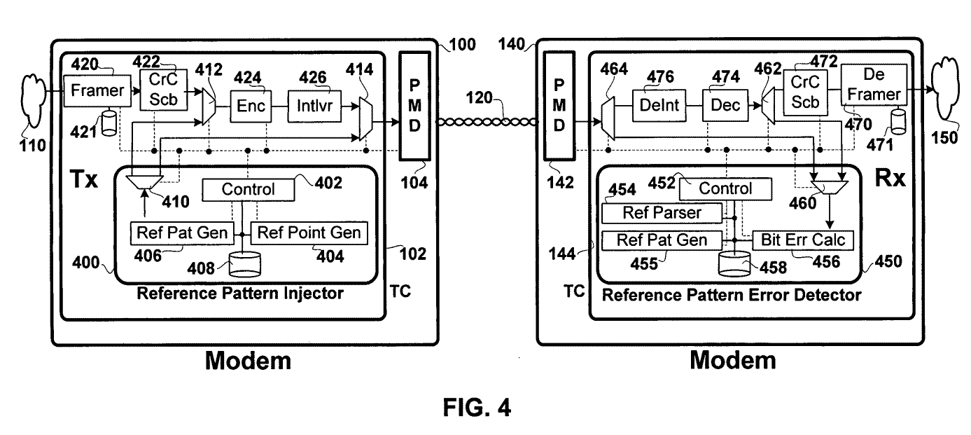

FIG. 4 is a detailed hardware block diagram of transmit and receive portions of the multi-tone modems 100 and 140 respectively. Each modem includes in its TC layer components a corresponding reference pattern module. These are the reference pattern injector 400 in modem 100 on the transmitting side and the reference pattern error detector 450 on the receiving side in modem 140.

The transmit portions of modem 100 include: a transmission convergence (TC) layer 102 which handles the byte level interface with network 110 and a physical media dependent (PMD) layer 104 which handles modulation of each byte of user data onto the subscriber line 120.

The transmit portion of the TC layer of modem 100 comprises: the framer 420 and associated state memory 421, a framer pipeline comprising components 422-426 and a reference pattern injector 400 coupled to the framer and pipeline. The framer pipeline comprises a cyclic redundancy check (CRC) and scrambler 422, a forward error correction (FEC) encoder 424, and an interleaver 426. These components operate under the control of the framer and the reference pattern injector. The CRC output can be used as a checksum to detect alteration of data during transmission. The scrambler scrambles the bits. The FEC implements Reed-Solomon encoding of transmitted data. The interleaver interleaves data to protect the transmission against burst errors.

The reference pattern injector 400 includes a controller 402, a reference pattern generator 406, storage 408, a reference pattern pointer generator 404 and associated multiplexers and demultiplexers 410-414 for coupling to the framer pipeline. The multiplexers allow pre-agreed reference patterns with or without encoding and interleaving to be injected directly into the datastream sent to the PMD layer 104 for modulation onto the subscriber line 120. The controller couples to all TC layer components as well as the mapper or tone orderer portion of the PMD layer.

The controller handles messaging between its modem and the remote modem during the discovery, negotiation and setup of reference pattern injection. Once entry into the per tone bit error determination mode is requested the controller obtains a copy of the bit allocation table from the mapper, a.k.a. tone orderer, in the PMD layer and stores the copy in storage 408. The controller also commences monitoring of a symbol synchronization signal provided by the PMD layer.

The reference pattern generator determines the pseudo random or other reference pattern sequence as well as the associated function, kernel, or lookup table identifier for same. These may be stored in storage 408 or computed during showtime. The parameters required to generate a copy of the reference pattern on the remote modem are sent by the controller to the remote modem during setup of reference pattern injection. The reference pattern pointer generator generates a symbol number and codeword or byte offset for the start of the negotiated reference pattern injection. These pointer(s) are passed to the remote modem during setup of reference pattern injection.

Once setup is complete the controller 402 handles the symbol synchronous and tone synchronous injection of reference data into the user data bitstream handled by the framer. The controller is responsive to the symbol synchronization signal from the PMD layer and the pointer value(s) generated by the reference pattern pointer generator to suspend the operation of the framer 420 at the appropriate bit in the user data bitstream. The framer saves the associated states for all framer pipeline components.

The controller injects the required number of bits of reference data from the reference pattern generated by the reference pattern generator using the bit loading for the targeted tone(s) as set forth in the bit loading table obtained from the mapper. The bit allocation table and the symbol synchronization signal allows the controller to identify in the TC layer datastream the TC layer bits that will correspond to the tone(s) targeted for reference pattern injection during setup. Thus no change in the PMD layer is required during reference data injection since the number of reference pattern bits loaded per tone is identical to the number of bits called for in the bit allocation table shared by both modems for showtime communication of user data.

In an embodiment of the invention the reference data derived from the reference pattern is injected iteratively into the same tone(s) in successive symbol intervals. This allows error detection to be conducted over an extended interval. To improve the accuracy of error detection the bits injected do not repeat in successive symbols. The controller in this embodiment of the invention maintains a sliding pointer to the reference pattern and increments the pointer after each injection, thus ensuring random bit values in successive injections of the reference data.

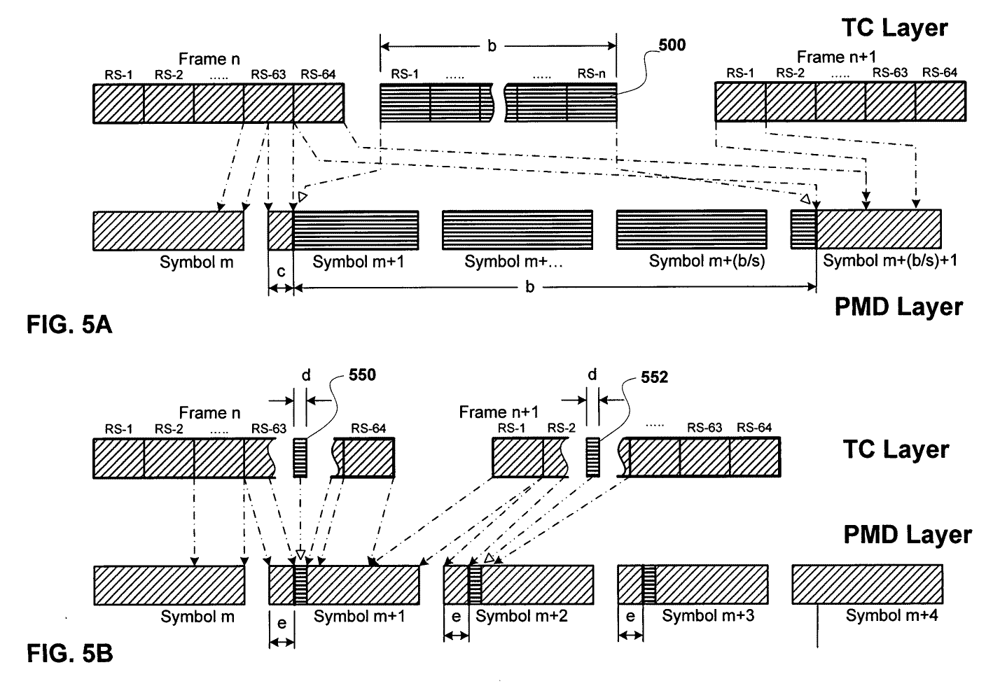

After injection of these bits into the ‘gap’ in the user data bitstream resulting from the temporary suspension of the framing, the controller re-enables the framer which restores its saved states and resumes processing of user data which follows the injected reference data. (See FIGS. 5A-5B).

Messaging may be carried out on an embedded operations channel (EOC). The messaging includes injection parameters identifying: reference data, injection type, injection frequency, injection duration, and starting and ending pointers of the reference pattern.

The reference data derived from the reference pattern, in an embodiment of the invention, is pseudo-random such that the same symbol is not repeated during an extended interval. The pattern can be generated by a pseudo-random generator. The pseudo-random generator has a period, say P bits, after which the pattern repeats. If the number of bits transmitted in a symbol, say S bits, is a multiple of P, then the same set of bits is sent every symbol. Similarly, if S is a sub-multiple of P, say S=k* P, then the set of bits modulated in a symbol repeats after every k symbols. To avoid this situation, after each symbol ends, some extra bits, say D bits, can be generated by the reference pattern generator 406 and discarded. The value of D should be chosen in the range 0 to ‘P−1’ such that (S+D) is relatively prime to P. This will generate P unique symbols before the symbols repeat. Alternately, if processing power is limited the reference pattern could be pre-computed and saved in memory 408 and then transmitted. However, depending on the modem's memory, it may not be practical to store a long enough sequence. So, a small buffer of pre-computed pattern can be kept in memory in a circular buffer and sent repeatedly. A new symbol will start sending from the bit next to the bit where the previous symbol finished. By keeping this buffer size, say B bits, to be relatively prime to S, the number of bits per symbol, each symbol will start at a different position, so that B unique symbols will be generated. To minimize memory, the pre-computed pattern of B bits cannot be too large, and therefore the B unique symbols generated may not be long enough for BER measurement. To handle this, a mask value can be generated using a pseudo-random generator, at the start of each symbol, and this mask can be XORed with each byte of the buffer before sending it. The required processing power is limited since the pseudo random generator is only used for generating a byte per symbol and the operation is only an XOR per byte.

The injection type e.g. inter-symbol or intra-symbol is also identified in the messaging communications between modems during injection setup. Intra-symbol type injection involves a selected subset of tones within each toneset or symbol the bits of which correspond to reference data while the remaining tones or sub-channels transport bits which correspond to user data. The subset of tones associated with intra-symbol injection may also change over time so that all tones in a toneset can be characterized in terms of bit error. Inter-symbol type injection involves the injection of reference data into entire symbols or tone sets during which interval transport of user data is suspended.

Messaging between local and remote modems 100 and 140 may also identify the frequency and duration of the reference pattern injection expressed for example in terms of the number of symbols or FEC codewords across which reference data will be injected and the gap between successive reference pattern injections. Starting and ending reference pattern pointers may also be identified in terms of symbol and or codeword number plus any applicable offsets. Alternately a starting pointer may simply involve a pre-agreed inversion of a SYN or other embedded signal provided for by the applicable PMD standard.

The receive portion of modem 140 includes: a TC layer 144 which handles the byte level interface with network 150 and a PMD layer 142 which handles modulation and demodulation of each byte of user data from the subscriber line 120.

The receive portion of the TC layer of modem 140 comprises: the deframer 470 and associated state memory 471, a deframer pipeline comprising components 472-476 and a reference pattern error detector 450 coupled to the deframer and pipeline. The deframer pipeline comprises a CRC and descrambler 472, an FEC decoder 474, and a deinterleaver 476. These components operate under the control of the deframer and the bit error detector.

The reference pattern error detector 450 includes a controller 452, a reference pattern parser 454, a reference pattern generator 455, a bit error calculator 456, storage 458, and associated multiplexers and demultiplexers 460-464 for coupling to the deframer pipeline. The multiplexers allow pre-agreed reference patterns with or without FEC decoding and deinterleaving to be extracted from the demodulated datastream received from the PMD layer 142. The controller couples to all TC layer components as well as the demapper or tone reorderer portion of the PMD layer.

The controller handles messaging between its modem and the remote modem during the discovery, negotiation and setup of reference pattern injection. Once entry into the per tone bit error determination mode is requested the controller obtains a copy of the bit allocation table from the demapper, a.k.a. tone reorderer, in the PMD layer and stores the copy in storage 458. The controller also commences monitoring of a symbol synchronization signal provided by the PMD layer.

The controller uses the symbol synchronization signal and the reference pattern pointer agreed on during setup to monitor the received user data stream and to suspend operation of the deframer at the point in the received datastream corresponding to the start of reference data (See FIGS. 5A-5B). The deframer saves state information for all components of the deframer pipeline at the time of suspension.

The controller passes the reference pattern bits to the reference pattern parser along with any required information as to the offset of the first extracted reference bit from the symbol boundary. Once the reference pattern is extracted the controller reenables the deframer which resumes operation using the states saved when it was suspended activity.

The reference pattern generator uses the setup parameters exchanged with the remote modem to generate the reference pattern which is stored in storage 458.

The reference pattern parser parses the received reference pattern bits parsing them into blocks corresponding to the individual tones on which they were communicated over the subscriber line. The reference pattern parser uses symbol boundary offset information from the controller as well as the copy of the bit allocation table to split the bits to correspond with their respective tone assignments. The reference pattern parser also performs the same tone specific parsing operation on the saved reference pattern generated by the reference pattern generator. The bit allocation table and the symbol synchronization signal allows the controller to identify in the received datastream in the TC layer the bits that correspond to the tone(s) targeted for reference pattern injection during setup. In an embodiment of the invention the reference pattern is injected iteratively into the same tone(s) in successive symbol intervals. The controller in this embodiment of the invention maintains a sliding pointer to the saved reference pattern and increments the pointer after each extraction and parsing thus ensuring comparison of the correct portion of the reference pattern with the extracted reference bits. These sliding pointers on the transmit and receive reference pattern modules assure that the portion of the reference pattern injected into a given symbol from the transmitting modem is compared the corresponding portion of the reference pattern by the receiving modem's reference pattern module. The reference pattern generator then passes each set of received bits for each tone along with the generated bits for the corresponding tone and passes these to the bit error calculator.

The bit error calculator takes the received and generated bits for each tone from the reference pattern parser and calculates the bit error of each tone by comparison of the generated bits with the received bits. The bit error of a tone is measured by counting the number of bits on the tone which are in error, and dividing the errored bit sum by the total number of bits on the selected tone in this period of time.

In operation the receive portion of modem 140 recreate the known reference pattern by reading a pre-computed pattern stored in memory, or by generating it with a pseudo-random generator using a kernel identified during the message enchanges associated with reference pattern injection setup. In an embodiment of the invention the bit error calculator 456 comprises an array of counters, containing a count for each tone. These are reset to zero, on entering the bit error (BER) measurement mode. The pattern is then compared with the bits demodulated from each tone: if it doesn't match, check how many bits are in error, and add it to the error counter for that tone.

In an embodiment of the invention BER of a tone is calculated as follows. If the number of bits carried by a tone is ‘b’ bits and if measurement is conducted for N symbols during which ‘e’ error bits are counted, then the BER on that tone is e/(N* b). The duration of the measurement should be long enough to generate enough number of errored bits based on the expected probability of error. This BER is the raw bit-error-rate and doesn't include the coding gain of any Reed-Solomon and interleaving.

If there are large number of bit-loaded tones and available memory is not sufficient for counters for each and every tone, then the counters can be reduced by having one counter for a group of consecutive tones. This will narrow the errors to a group(s) of tones, and a second set of measurements can be done after analysis of BER for tone groups to count the errors on a per tone basis only in this errored set of tones. If there is a high data rate and/or large number of bit loaded tones either the processing power needed to compute the bits and compare all the tones or the memory needed for all the counters may not be sufficient to process all the tones every symbol. In such cases, the BER computation can be done in phases using intra-symbol injection of reference data, with each phase handling a small number of the tones. If for example the bit error calculator can compare 512 tones every symbol, and there are 2048 bit loaded tones to be checked then the BER can be done in 4 phases, with each phase doing the BER for 512 tones at a time. When BER is calculated in phases using intra-symbol injection it is useful to have the transmitter use the pre-computed buffer method for sending the reference pattern. The method of generating the pattern with a pseudo-random generator at run-time requires the receiver to generate the entire symbol even if it is going to use only a part of it. With the pre-computed buffer method the receiver can, with some simple address calculations, find the sequence of bytes which corresponds to the set of tones being checked.

The overall BER of the modem, as opposed to the bit error per tone, can be calculated by adding all the error counters, and dividing by the overall number of bits. For example, if E is the sum of the error counters of all the tones, and S is the number of bits transmitted per symbol, then the overall BER is E/(N*S).

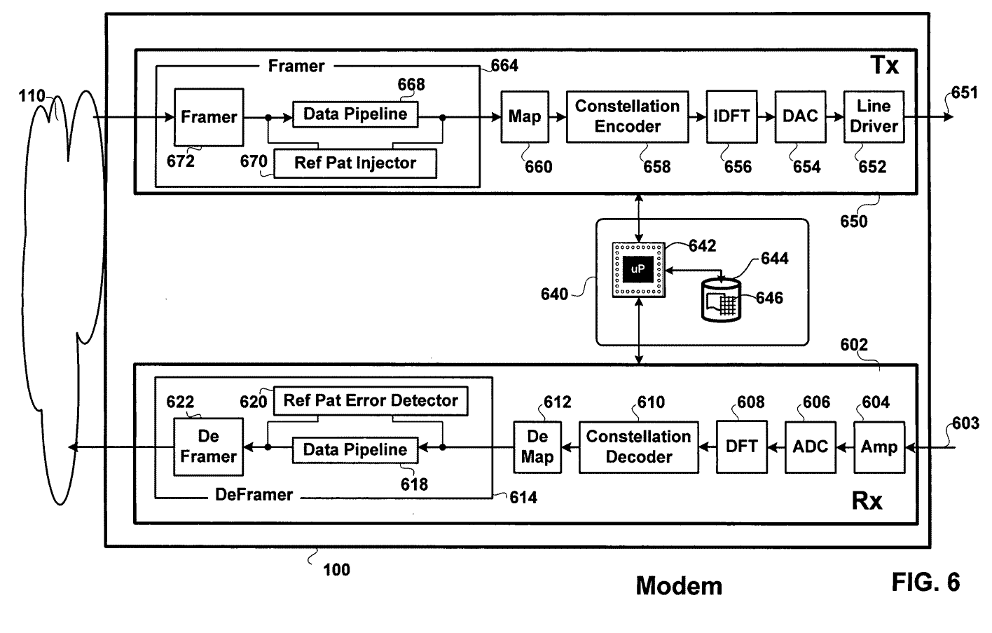

If the processing needed is to be minimized, then an approximate measurement can be done initially to identify at a coarse level the set of tones which have errors, and then the above mentioned accurate method can be used to check only for these set of few tones. The comparison of each tone requires lot of bit shifting and masking, to extract the bits of a tone and then compare. Instead the comparison can be done for each byte position in the TC layer. Then, the normal output of the receive PMD layer can be compared for each byte (or word) position by an XOR operation with the corresponding reference pattern byte (or word). This counts the errors for each byte position in the set of bytes sent to the TC layer every symbol. At the end of this measurement the bit table used by the mapper/tone-orderer 660 (See FIG. 6) in the PMD layer can be used to ‘reverse-map’ each byte position to the tones which could have caused error at that byte position. Since multiple tones can generate bits which are packed into a byte this coarse method does not indicate which of the tones associated with the byte was responsible for how much of the errors generated at that byte. One method is to assume each bit in the byte has equal probability of being in error. If a byte position has ‘e’ bit errors, e/8 errors are assigned to each bit position in that byte. Thus, if a tone has ‘b’ bits which gets packed into that byte position then that tone can be assigned (b*e/8) bit errors. This coarse measurement gives an approximate BER per tone measurement since the distribution of errors within a byte is time consuming to determine. This coarse BER per tone measurement technique can be used to narrow down the errors to a region of tones, and then the previously mentioned accurate per tone measurement can be done only for that set of tones.

The DSL framing/de-framing parameters and counters and interleaver/de-interleaver memory are kept unchanged in the BER per tone measurement mode, so that when the modem is transporting user data the framing continues from where it last left off. In the BER measurement mode only the showtime data symbols are replaced with the reference pattern. The sync symbols are transmitted at their normal position unchanged. These sync symbols can be used at the end of reference data injection to signal a return to normal showtime mode by sending an inverted sync again.

FIG. 5A is a data transport diagram showing user and reference data in both the transmission convergence (TC) layer and the physical media dependent (PMD) layer for an embodiment of the invention utilizing inter-symbol injection. The reference pattern is injected to all tones in each symbol, with the exception of any fragmentation at the start or end of the injection. A reference pattern 500 comprising “b” bytes of reference data is injected into the transmitted symbols of the PMD layer. In an embodiment of the invention a pointer identifying the starting symbol (m+1) and the offset “c” within that symbol is exchanged during the reference pattern injection setup by the opposing modems so that the receiving modem can determine the onset of the reference pattern.

Alternate embodiments of the invention indicate the start of BER measurement mode with an inverted sync symbol with the pre-agreed convention that the BER measurement will start in some ‘n^{th}’ symbol after the inverted sync symbol. Instead of an offset of ‘c’ bytes within the first symbol, the start could be implicitly specified as following the completion of any unfinished codeword from the previous symbol, e.g. codeword RS-63 in FIG. 5A. In another embodiment of the invention the reference pattern data can also be sent through the FEC encoder and interleaver, when it is desired to check the BER of the modem taking into account the gain from the FEC and interleaving.

FIG. 5B is a data transport diagram showing user and reference data in both the TC layer and the PMD layer for an alternate embodiment of the invention for an embodiment of the invention utilizing intra-symbol injection. The reference pattern is injected into a selected subset of the tones in each symbol. A reference pattern 550 and 552 comprising “d” bytes of reference data, without encoding and without interleaving, is injected into the transmitted symbols of the PMD layer. A pointer identifying the starting symbol (m+1) and the offset “e” within that symbol is exchanged during the reference pattern injection setup by the opposing modems along with the duration of the injection so that the receiving modem can determine the onset of the reference pattern and the number of symbols over which the intra-symbol injection will take place.

FIG. 6 is a detailed hardware block diagram of both the transmit and receive portions of the modem 100 shown in FIG. 1. The modem has a transmit path 650 with an input coupled to the network 110 and an output 654. The modem has a receive path 602 with input 603 and an output coupled to the network 110. Network 110 may for example comprise: an Ethernet, an IP or an ATM network. A controller 640 is shown coupled to both the transmit and receive paths for control thereof. The controller includes a control processor 642 and memory 644. The memory includes set up parameters such as channel assignments and runtime parameters such as gain tables and bit loading tables for the one or more communications channels handled by the modem. The modem's transmit and receive paths 650 and 602 respectively comprise a plurality of TC and PMD components coupled to one another to transmit and receive communication channels over the subscriber line or other wired or wireless medium to which the modem is coupled.

On the transmit path 650 the TC layer components comprise the framer 664 which includes: a framer module 672, a framer data pipeline 668, and a reference pattern injector 670. Generally, the framer 664 momentarily suspends framing of user data before processing bits associated with the tones targeted for reference data transport and injects the pre-agreed reference pattern therein, after which framing of user data resumes. The functioning of these components corresponds to that of the associated components described in detail in connection with FIG. 4 (See Modem 100, FIG. 1). The framer handles the framing of user data, the framer pipeline handles CRC, scrambling, encoding and interleaving of user data, and the optional encoding and interleaving of reference data. The reference pattern injector handles the setup of reference pattern injection with a remote modem and the generation of a reference pattern and the injection of the reference pattern into the byte stream sent to the PMD layer for transmission across the subscriber line. The PMD layer components on the transmit path include: mapper (a.k.a. tone orderer) 660, constellation encoder 658, inverse discrete Fourier transform (IDFT) module 656, digital-to-analog converter (DAC) and line driver 652. The mapper maps the bits received from the TC layer to the appropriate sub-channels or tones modulated by the IDFT. The constellation encoder encodes the bits for each sub-channel into the appropriate complex number corresponding to the required phase and amplitude modulation of the sub-carrier signal representing the mapped bits. The IDFT transforms the transmitted data from the frequency to the time domain. The DAC performs the necessary analog conversion and the line driver amplifies the resultant signal 651 onto the subscriber line or other communication medium.

On the receive path the PMD layer components comprise: the amplifier 604, the analog-to-digital converter (ADC) the discrete Fourier Transform (DFT) module 608, the constellation decoder 610 and the demapper, a.k.a. tone reorderer, 612. The amplifier amplifies the received signal and the ADC digitizes it. The DFT transforms the received signal from the time to the frequency domain. The constellation decoder converts the complex number corresponding to the phase and amplitude of the received signal to corresponding bits which are then reordered to correspond with the byte order of the transmitted bits and delivered to the TC layer components. On the receive path 602 the TC layer components comprise the deframer 614 which includes: a deframer module 622, a deframer data pipeline 618, and a reference pattern error detector 620. Generally the deframer 614 momentarily suspends deframing of received user data bits before processing bits associated with the tones targeted for transport of pre-agreed reference data and extracts the received reference bits thereof for comparison with the corresponding pre-agreed reference bits to determine errors therein, after which deframing of user data resumes. The functioning of these components corresponds to that of the associated components described in detail in connection with FIG. 4 (See Modem 140, FIG. 1). The deframer handles the deframing of user data, the deframer pipeline handles CRC, descrambling, decoding and deinterleaving of user data, and the optional decoding and deinterleaving of reference data. The reference pattern error detector detects the reference pattern in one or more tones of the received data and determines bit errors therein.

In an embodiment of the invention mapper 660 and demapper 612 include corresponding trellis encoders and decoders. When trellis coding is enabled, the trellis encoder at the start of the mapper, modifies some of the data bits and creates additional bits. For example, if the framer sent ‘Ls’ bits per symbol to the PMD layer, the trellis encoder would add some ‘Lt’ bits and output ‘Ls+Lt’ bits, which are then modulated and transmitted on the tones. Note that the sum of the bits loaded on the various tones in the bit table in this case will be ‘Ls+Lt’ bits. The demapper typically uses a Viterbi decoder to combine the information from several tones to correct errors (if any) up to certain level of errors, discards the extra bits and outputs ‘Ls’ bits to the receive TC layer. The BER per tone method described earlier provides the BER of a tone attributed to the PMD layer including the trellis coding. It is sometimes useful, when trellis coding is enabled, to check the raw BER of a tone without trellis coding. To do this, one of the options, when the BER is being measured for all the tones, is to keep the bit table as is, and disable trellis encoding and decoding. Now, when trellis encoder is disabled, the reference pattern generator must generate the extra bits which would have been generated by the trellis encoder and send ‘Ls+Lt’ bits to the PMD layer. And on the receive, the error check must be made for ‘Ls+Lt’ bits output by receiver's PMD layer.

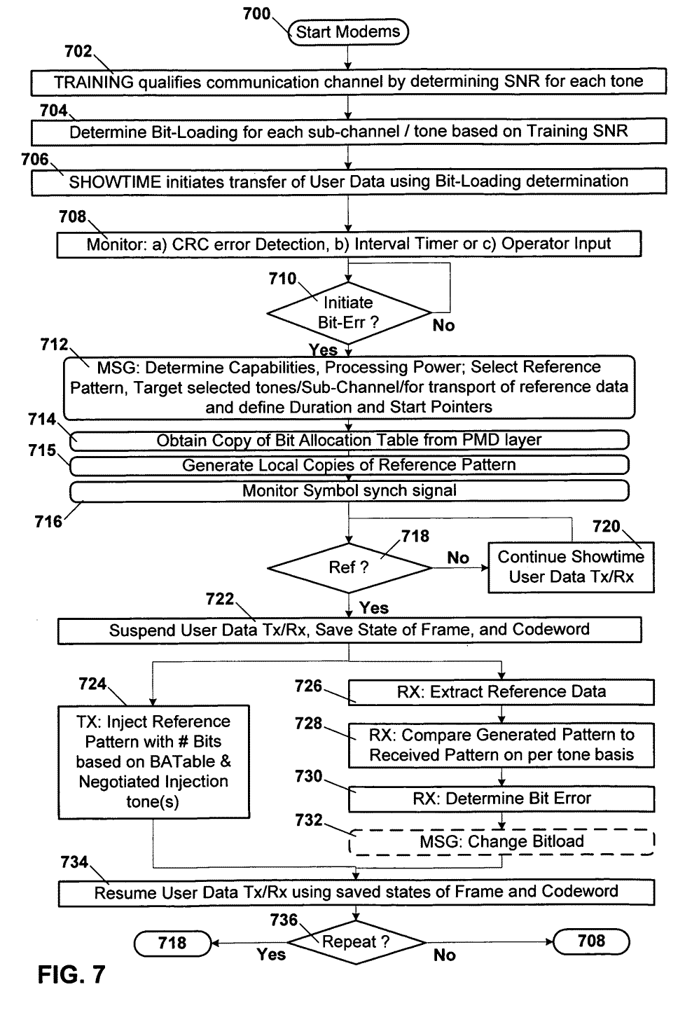

FIG. 7 is a process flow diagram of transmit and receive processing for the modems shown in FIG. 1 in accordance with an embodiment of the invention. At startup 700 opposing modems initiate initial communications with one another. In process 702 the modems enter what is typically identified as a training phase of operation in which no user data is transported and in which the communication channel is qualified. Qualification of the communication channel is expressed in terms of the signal-to-noise ratio (SNR) for each sub-channel or tone modulated onto the communication medium, e.g. subscriber line. After SNR for each tone is determined the bit loading for each tone or sub-channel is calculated based on the measured SNR and the available power for each sub-channel. Bit loading on a sub-channel is proportional to the SNR for the channel determined during training. The resultant bit loading table, agreed to by the opposing modems, indicates both the sequence in which bytes are to be allocated to tones and for each tone the number of bits that can be modulated onto that tone. Next in process 706 the modems enter showtime operation which initiates transfer of user data with the bit loading of each sub-channel or tone governed by the bit loading table determined in the training phase. During showtime either or both opposing modems conduct some form of monitoring for initiating entry into per tone bit error detection mode. Monitoring in an embodiment of the invention is based on CRC errors above a threshold level. Monitoring in an alternate embodiment of the invention is based on a countdown or interval timer the zero level of which corresponds to a request to initiate per tone bit error detection. Monitoring in an alternate embodiment of the invention is based a reduction of user data input for a period of time which indicates the link is not being fully used by the user and that BER reference data can be sent instead. In still another embodiment of the invention monitoring comprises a detection of a operator input corresponding to a request to initiate per tone or sub-channel bit error detection.

In decision process 710 a determination is made based on the prior monitoring, as to whether or not to initiate per tone bit error detection mode. In the event of an affirmative determination control passes to process 712. In process 712 the opposing modems engage in messaging required to setup per tone bit error detection. The messaging is effected using an EOC or other in line control signaling protocol. The modems exchange capabilities including BER support and available processing power for example. The modems negotiate a reference pattern. They also establish the tone(s) targeted for transport of the negotiated reference pattern, e.g. the reference pattern type, inter-symbol or intra-symbol. The modems also establish the frequency and duration of the reference pattern injection. This may be expressed in terms of the number of successive symbols over which injection will occur. These tones targeted for transport of the pre-agreed reference pattern, Finally any required pointers which mark the starting point, e.g. symbol number and offset, of the reference pattern injection are exchanged. Pointers as discussed above can in an embodiment of the invention comprise a frame number, a symbol number an FEC codeword number along with any associated offset. In an alternate embodiment of the invention reference pattern injection is initiated by an in channel signal such as an inversion of a sync symbol followed by the reference pattern with or without an offset. During reference pattern injection user data rates are reduced by an amount proportionate to the number of bits loaded on the targeted tones in each symbol or toneset targeted for the transport of reference data.

Next in process 714 both of the opposing modems obtain a copy of the bit allocation table established by the modems and used by the PMD layer of each of loading and unloading user data in appropriate numbers of bits into corresponding tones, a.k.a. sub-channels. Then in process 715 both modems reference pattern modules, i.e. the reference pattern injector on the transmitting side and the reference pattern error detector on the receiving side (See FIG. 4 modules 400 and 450 respectively), generate the negotiated reference pattern which they each store locally. In process 716 both modems reference pattern modules commence monitoring of the symbol synchronization signal received from their respective PMD layers.

In decision process 718 each of the opposing modems determines whether to initiate reference pattern injection or detection. This decision is based on the associated symbol synchronization signal and the reference pattern pointer(s) established by the modems during setup of the BER mode. If the start point for reference pattern injection or extraction is not detected then showtime transmission and reception of user data continues in process 720. If the transmitted or received bit stream is at the point where reference pattern injection or extraction is to commence then control passes to process 722.

In process 722 each modems corresponding reference pattern module suspends the associated one of user data transmission or reception as required and saves the associated state of the framer/deframer and associated pipeline component states, e.g. CRC, FEC codeword, scrambler and interleaver.

Next the processes are split into those performed on the modem injecting the reference pattern and those performed on the modem extracting the reference pattern.

The transmit process 724 is carried out on the reference pattern injecting one of the opposing modems. In transmit process 724 the negotiated reference pattern is injected into the TC layer of the transmitting modem's transmit path and transmitted to the opposing modem by the PMD layer components. In process 724 the reference pattern module on the transmitting modem injects the required number of bits of the reference pattern using the bit loading for the targeted tone(s) as set forth in the bit loading table obtained from the PMD layer mapper. In embodiments of the invention in which injection is repeated across symbols, the reference pattern module may additionally increment a sliding reference pattern pointer after each injection thus ensuring the uniqueness of each injection interval. After injection of these bits into the ‘gap’ in the transmitted user data bit stream resulting from the temporary suspension of the framing control passes to process 734. In an embodiment of the invention the tones targeted for transport of reference pattern bits varies across successive symbols, a.k.a. tonesets, in a manner pre-agreed by the modems during the BER mode setup. For example, in a first symbol interval tones 100-199 are targeted for transport of reference pattern bits with remaining tones transporting user data. Then in the next symbol interval tones 200-299 are targeted for transport of reference pattern bits with remaining tones transporting user data. After all tones have been targeted in this manner a complete characterization of the per tone bit errors on the communication channel can be determined. This allows a complete toneset, a.k.a. symbol, to be characterized as to per tone bit errors and allows uninterrupted user data transport on remaining untargeted tones.

The receive process 726 carried out by the reference pattern module of the receiving one of the pair of modems. In receive process 726 the reference pattern is extracted. Next in process 728 the received reference pattern bits are parsed into blocks corresponding to the individual tones on which they were communicated over the subscriber line using the tone/sub-channel allocations negotiated during setup and the local copy of the bit allocation table to split the bits to correspond with their respective tone assignments. These are compared with the corresponding bits of the locally generated copy of the reference pattern. In embodiments of the invention in which injection is repeated across symbols, the reference pattern module may additionally increment a sliding reference pattern pointer after each extraction thus ensuring comparison of the appropriate reference pattern and extracted bits. Then in process 730 the per tone errors between the received reference pattern and the generated reference pattern are determined. Next in the optional step 732 any messaging or upload of per tone bit errors is engaged in. This may result in alterations to the bit loading table using seamless rate adaption (SRA) or other existing protocol. After extraction of these bits from the ‘gap’ in the received user data bitstream and error calculation control passes to process 734.

After transmit and receive processing of the reference pattern, i.e. injection and extraction of reference pattern, control passes to process 734. In process 734 the reference pattern modules on each modem re-enable the associated framer and deframer which resume their respective operations on user data using the saved states from the onset of injection.

Next in decision process 736 a determination is made as to whether subsequent injection intervals were identified during the setup of per tone bit error detection. If so, control returns to decision process 718 for detection of the next reference pattern on either an inter-symbol or intra-symbol basis. If reference pattern injection and detection is complete control returns to monitoring process 708.

In an embodiment of the invention a single modem can support concurrent reference pattern injection on the transmit path and per tone bit error detection on the receive path, with a similarly configured opposing modem without departing from the scope of the claimed invention.

The foregoing description of a preferred embodiment of the invention has been presented for purposes of illustration and description. It is not intended to be exhaustive or to limit the invention to the precise forms disclosed. Obviously many modifications and variations will be apparent to practitioners skilled in this art. It is intended that the scope of the invention be defined by the following claims and their equivalents.

What is claimed is:

1. A transceiver with a plurality of components coupled to one another to form a transmit path and a receive path for multi-tone modulation of user data across a communication medium; and the transceiver comprising:
a framer configured to momentarily suspend framing of user data before processing bits associated with tones targeted for reference data transport and to inject the pre-agreed reference pattern therein, after which framing of user data resumes; and
a deframer configured to momentarily suspend deframing of received user data bits before processing bits associated with the tones targeted for transport of pre-agreed reference data and to extract the received reference bits thereof for comparison with the corresponding pre-agreed reference bits to determine errors therein, after which deframing of user data resumes.

2. The transceiver of claim 1, wherein the tones targeted for reference data transport comprise a subset of the tones in a symbol with remaining tones transporting user data bits.

3. The transceiver of claim 1, wherein the tones targeted for reference data transport comprise a subset of the tones in a symbol and wherein further the targeted tones vary across successive symbol intervals.

4. A method for operating a transceiver configured to support multi-tone modulation of user data across a communication medium; and the method comprising:
momentarily suspending framing of a bitstream of user data before processing bits associated with tones targeted for reference data transport;
injecting a pre-agreed reference pattern into the user data bitstream responsive to the momentary suspension;
momentarily suspending deframing of a received bitstream of user data before processing bits associated with the tones targeted for transport of pre-agreed reference data;
extracting the received reference bits thereof responsive to the second momentary suspension act; and
comparing corresponding pre-agreed reference bits with the received reference bits extracted in the extracting act to determine errors therein.

5. The method for operating a transceiver of claim 4, further comprising:
targeting a selected subset of tones for reference data transport and remaining tones for transport of user data.

6. The method for operating a transceiver of claim 4, further comprising:
targeting in a first symbol interval a first selected subset of tones for reference data transport and remaining tones transporting user data bits; and
targeting in a second symbol interval a second selected subset of tones distinct from the first selected subset of tones for reference data transport and remaining tones transporting user data bits.

7. A means for operating a transceiver configured to support multi-tone modulation of user data across a communication medium; and the means comprising:
means for momentarily suspending framing of a bitstream of user data before processing bits associated with tones targeted for reference data transport;
means for injecting a pre-agreed reference pattern into the user data bitstream responsive to the means for momentarily suspending framing;
means for momentarily suspending deframing of a received bitstream of user data before processing bits associated with the tones targeted for transport of pre-agreed reference data;
means for extracting the received reference bits thereof responsive to the second means for momentarily suspending framing; and
means for comparing corresponding pre-agreed reference bits with the received reference bits extracted by the means for extracting to determine errors therein.

8. The means for operating a transceiver of claim 7, further comprising:
means for targeting a selected subset of tones for reference data transport and remaining tones for transport of user data.

9. The means for operating a transceiver of claim 7, further comprising:
means for targeting in a first symbol interval a first selected subset of tones for reference data transport and remaining tones transporting user data bits; and
means for targeting in a second symbol interval a second selected subset of tones distinct from the first selected subset of tones for reference data transport and remaining tones transporting user data bits.

10. In a communications system having a pair of modems supporting multi-tone modulated communication of user data over a subscriber line, the improvement comprising:
a framer in a first of the pair of modems configured to momentarily suspend framing of user data before processing bits associated with tones targeted for reference data transport and to inject a pre-agreed reference pattern therein, after which framing of user data resumes; and
a deframer in a second of the pair of modems configured to momentarily suspend deframing of received user data bits before processing bits associated with the tones targeted for transport of the pre-agreed reference data and to extract the received reference bits thereof for comparison with the corresponding pre-agreed reference bits to determine errors therein, after which deframing of user data resumes.

11. The communications system of claim 10, wherein the tones targeted for reference data transport comprise a subset of the tones in a symbol with remaining tones transporting user data bits.

12. The communications system of claim 10, wherein the tones targeted for reference data transport comprise a subset of the tones in a symbol and wherein further the targeted tones vary across successive symbol intervals.

13. A method for operating a pair of modems configured to couple to one another via a subscriber line for multi-tone modulated communication of user data thereon, and the method comprising:
momentarily suspending framing of a bitstream of user data, in a first of the pair of modems, before processing bits associated with tones targeted for reference data transport;
injecting, in the first of the pair of modems, a pre-agreed reference pattern into the user data bitstream responsive to the momentary suspension;
momentarily suspending deframing of a received bitstream of user data, in a second of the pair of modems, before processing bits associated with the tones targeted for transport of pre-agreed reference data;
extracting, in the second of the pair of modems, the received reference bits responsive to the second momentary suspension act; and
comparing, in the second of the pair of modems, corresponding pre-agreed reference bits with the received reference bits extracted in the extracting act to determine errors therein.

14. The method for operating a modem of claim 13, further comprising:
targeting a selected subset of tones for reference data transport and remaining tones for transport of user data.

15. The method for operating a modem of claim 13, further comprising:
targeting in a first symbol interval a first selected subset of tones for reference data transport and remaining tones transporting user data bits; and
targeting in a second symbol interval a second selected subset of tones distinct from the first selected subset of tones for reference data transport and remaining tones transporting user data bits.

16. A means for operating a pair of modems configured to couple to one another via a subscriber line for multi-tone modulated communication of user data thereon, and the means comprising:
means for momentarily suspending framing of a bitstream of user data, in a first of the pair of modems, before processing bits associated with tones targeted for reference data transport;
means for injecting, in the first of the pair of modems, a pre-agreed reference pattern into the user data bitstream responsive to the means for momentarily suspending;
means for momentarily suspending deframing of a received bitstream of user data, in a second of the pair of modems, before processing bits associated with the tones targeted for transport of pre-agreed reference data;
means for extracting, in the second of the pair of modems, the received reference bits responsive to the second means for momentarily suspending; and
means for comparing, in the second of the pair of modems, corresponding pre-agreed reference bits with the received reference bits extracted by the means for extracting to determine errors therein.

17. The means for operating a modem of claim 16, further comprising:
means for targeting a selected subset of tones for reference data transport and remaining tones for transport of user data.

18. The means for operating a modem of claim 16, further comprising:
means for targeting in a first symbol interval a first selected subset of tones for reference data transport and remaining tones transporting user data bits; and
means for targeting in a second symbol interval a second selected subset of tones distinct from the first selected subset of tones for reference data transport and remaining tones transporting user data bits.
